(19) United States
(12) Patent Application Publication
(10) Pub. No.: US 2016/0063822 A1
(43) Pub. Date: Mar. 3, 2016

(54) SWITCHING DEVICE, RECEIVING DEVICE AND METHOD

(71) Applicant: Siemens Aktiengesellschaft, München (DE)

(72) Inventors: Bernd SCHWINN, Fuerth (DE); Michael STRASSBURGER, Ensdorf (DE)

(21) Appl. No.: 14/799,606

(22) Filed: Jul. 15, 2015

(30) Foreign Application Priority Data
Aug. 29, 2014 (DE) 102014217332.9

(51) Int. Cl. G08B 5/24; G08B 5/36; H04B 5/00

(52) U.S. Cl. CPC G08B 5/24; H04B 5/0062; G08B 5/36

(57) ABSTRACT

A switching device, particularly a circuit breaker, is disclosed for interrupting at least one electrical circuit. The switching device has various operating information that is signaled mechanically and is captured mechanically via at least one module and made available via signaling contacts. The module is embodied such that the mechanical signaling energy is converted into electric power and this electric power is supplied to a radio module in order to send the signaled operating information via a radio message.

### PRIORITY STATEMENT

The present application hereby claims priority under 35 U.S.C. §119 to German patent application number DE 102014217332.9 filed Aug. 29, 2014, the entire contents of which are hereby incorporated herein by reference.

### FIELD

At least one embodiment of the present invention generally relates to a switching device, a receiving device and/or a method.

### BACKGROUND

Switching devices, such as circuit breakers, are used for interrupting electrical circuits. By way of example, circuit breakers are used as a kind of switchgear for switching high currents. Not only can they switch operating currents and small overload currents, they can also switch high overload currents or short-circuit currents in the event of faults. They can additionally hold fault currents for a prescribed time and safely disconnect them. There are circuit breakers with different numbers of poles, such as single pole, two pole, three pole or four pole, etc. Apart from the use as a simple switching element, circuit breakers are used as line protection in the event of faults such as short circuit, overcurrent, leakage current or ground fault.

By way of example, switching devices may be molded case circuit breakers, air circuit breakers or miniature circuit breakers. These are used on different distribution levels in power distribution, such as main distribution, sub-distribution, etc.

Switching devices, particularly circuit breakers, can adopt various operating states or statuses, such as “on”, “off”, “tripped”. These are displayed as operating information. The operating information made available may be further information relating to the switch status, for example reason for tripping, notifications of maintenance, etc.

Much operating information is frequently displayed mechanically, for example by signaling strikers, mechanical switching elements or mechanical levers. When the operating state changes, a movement puts these mechanical display elements into a different position that signals the changed operating information.

Many switching devices afford the option of fitting functional modules, for example statically to begin with, but also later as an option. These modules pick up the signaled piece of operating information or the signaled pieces of operating information mechanically and make it/them available via signaling contacts, such as electrical contacts, for example “break contacts”, “make contacts” or “changeover contacts”. By way of example, these signaling contacts can have lines or cables connected to them that can be laid externally in order to display the operating information at remote locations.

### SUMMARY

At least one embodiment of the present invention improves the display of operating information.

At least one embodiment of the present invention is directed to a switching device, a receiving device and/or a method. According to at least one embodiment of the invention, the switching device has a module that is embodied such as to convert mechanical energy into an electric power that is supplied to a radio module in order to send the mechanically signaled operating information of the switching device via a radio message. This has the particular advantage that operating information from a switching device can be displayed at a remote location without the connection of lines. In addition, it has the particular advantage that operating information can be sent independently of an external power supply.

Advantageous embodiments of the invention are specified in the subclaims.

In one advantageous embodiment of the invention, a receiving device is embodied such that operating information from a plurality of radio modules can be received and displayed. This has the particular advantage that a plurality of pieces of operating information from one switching device or pieces of operating information from a plurality of switching devices can be displayed together, so that user-friendly monitoring of switching devices is made possible.

In one advantageous embodiment of the invention, a method is disclosed for a switching device, particularly a circuit breaker, for interrupting at least one electrical circuit, wherein the switching device signals various operating information mechanically, said operating information being captured mechanically and made available via signaling contacts. The mechanical signaling energy is converted into electric power and this electric power is used to produce a radio message that contains the signaled operating information.

### BRIEF DESCRIPTION OF THE DRAWINGS

An example embodiment of the invention is shown in the drawing and is described in more detail below. In the drawing,

FIG. 1 shows a representation of a switching device,

FIG. 2 shows a representation of a switching device having a receiving device.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

At least one embodiment of the present invention is directed to a switching device, a receiving device and/or a method. According to at least one embodiment of the invention, the switching device has a module that is embodied such as to convert mechanical energy into an electric power that is supplied to a radio module in order to send the mechanically signaled operating information of the switching device via a radio message. This has the particular advantage that operating information from a switching device can be displayed at a remote location without the connection of lines. In addition, it has the particular advantage that operating information can be sent independently of an external power supply.

In one advantageous embodiment of the invention, a piezoelectic element is provided for converting the mechanical energy into electric power. This has the particular advantage that a particularly simple opportunity for energy conversion is specified.

In one advantageous embodiment of the invention, the radio module provided is a radio frequency identification module or RFID module. For example, the RFID module may be an active RFID transponder. This has the particular advantage that an already existent technique can be used for sending the radio message, which means that a simple and inexpensive opportunity for realization is available.

In one advantageous embodiment of the invention, the radio message is a short message or short radio message. This has the particular advantage that low mechanical energies can also be used for a radio message.

In one advantageous embodiment of the invention, the receiving device is embodied such that operating information from a plurality of radio modules can be received and displayed. This has the particular advantage that a plurality of pieces of operating information from one switching device or pieces of operating information from a plurality of switching devices can be displayed together, so that user-friendly monitoring of switching devices is made possible.

In one advantageous embodiment of the invention, the receiving device has at least one signaling contact provided on it that makes a piece of operating information available. This has the particular advantage that operating information is not just displayed by the receiving device but is also available in customary fashion via signaling contacts for further purposes. By way of example, it is thus possible for switching devices that are installed at locations with poor accessibility that allow the (subsequent) laying of lines to the signaling contacts only with difficulty to transmit, by virtue of the invention, the operating information by radio to a location with better accessibility and to a receiving device according to the invention, at which it is then in turn possible to connect lines to the signaling contacts of the receiving device. This has the advantage that simple extension of existing systems and installation friendliness are available.

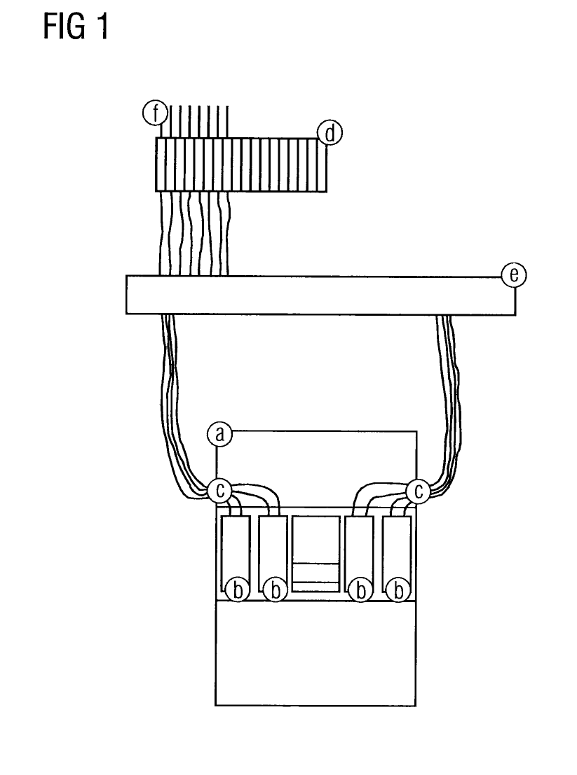

FIG. 1 shows a basic representation of a switching device a, such as a circuit breaker, having a plurality of modules b that, by way of example, can capture various operating information or operating states such as “on”, “off” or “tripped”. These modules b have various lines c connected to them. If need be, these lines c can be routed outside via cutouts, apertures or bushings on the device housing. The lines c are routed via a cable duct e to a terminal strip d, where the lines are placed. This terminal strip d has further lines f connected to it that carry forward the operating information from the switching device.

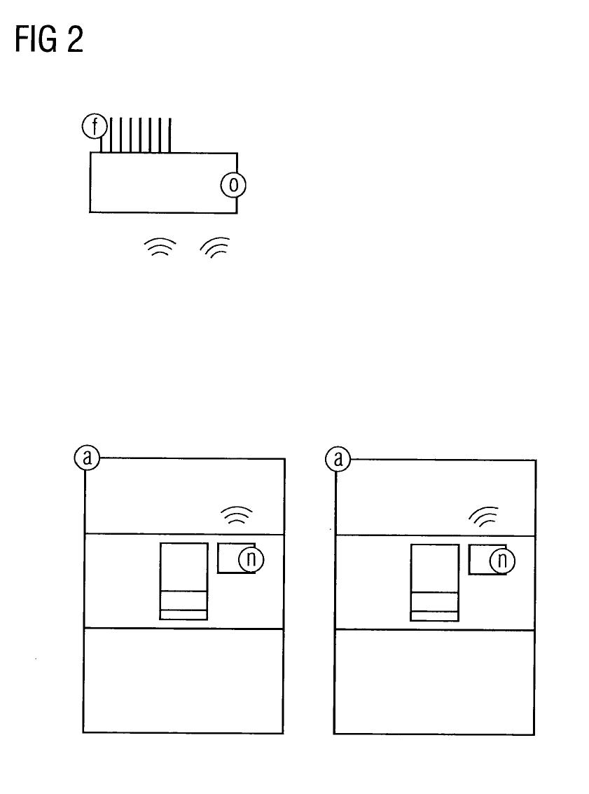

FIG. 2 shows two circuit breakers a that each have a module n according to an embodiment of the invention that converts the mechanical operating information into electrical operating information and sends it wirelessly by means of a radio message. The conversion of the mechanical energy, for example from a signaling striker, into electric power can be carried out by a piezoelectic element, for example. Any other possibility of converting mechanical energy into electric power is also conceivable, however.

When the mechanical operating information changes, this mechanical change movement is used so as to be converted into electric power.

This power is supplied to a radio module, which then sends a radio message. By way of example, one dedicated radio message is sent per signaled piece of operating information (and possibly switching device).

The radio module may be an RFID module, for example. By way of example, it may be an active RFID transponder. These produce a previously definable specific modulated signal. The range may be from a few meters to kilometers, depending on the frequency and transmission power and also shielding behavior of the environment. Alternatively, any other solution is conceivable, for example using wireless communication modules.

A receiving device o for these radio messages, for example a central receiving device, receives them. In this case, the receiving device can receive messages from a plurality of modules or switching devices. The radio messages may be short messages or short radio messages. The operating information from the radio messages is displayed on the receiving device o (not shown).

The receiving device o can have a terminal connection f, as in FIG. 1, where the operating information is available in a known manner, such as through break contacts, make contacts or changeover contacts or other kinds of contacts, and to which lines can be connected.

An embodiment of the present invention will be explained once again below.

An embodiment of the module is embodied such that it can be either permanently integrated in the switching device or installed as an option.

The mechanical operating information from the switching device is now transmitted no longer by way of lines or cables but rather via a radio message or radio link. This radio message can be realized using a simple technique that is active only in the short range and requires little power, for example. By way of example, it can be realized using radio frequency identification or RFID.

According to an embodiment of the invention, the energy from a signaling striker of a switching device is converted into electric power, for example by a piezoelectic element, with the electric power then being used to send the changed status of the switching device via a short message using a radio link. This has the advantage that the previous complex and fault-prone wiring from and to these modules using lines or cables is replaced by a radio message. By way of example, this radio message can be used within a switchgear cabinet.

The generation of electric power that is used for sending the radio message or the message that it is not necessary to route lines to the switching device. The space requirement can be reduced, since the modules do not need to have terminal areas for lines. The switching device can be of smaller construction or further supplementary functions of other kinds could be integrated. The radio modules operate self-sufficiently in terms of power. There is no requirement for auxiliary power for sending radio messages. The (central) receiving device can be used in order to receive information from a plurality of switching devices, to combine said information and/or to make it available externally via terminal connections.

Routing through and connecting the lines to a switching device had previously required apertures or cutouts, particularly on the housing. These can now be dispensed with. This reduces the complexity of work and there are additionally fewer openings present that could collect dirt.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### LIST OF REFERENCE SYMBOLS

a Switching device

b Module

c Lines

d Terminal strip

e Cable duct

f Further lines

n Module according to the invention

o Receiving device

What is claimed is:

1. A switching device for interrupting at least one electrical circuit, the switching device comprising:
at least one module to mechanically signal and capture operating information, the operating information being made available via signaling contacts, the module being embodied to convert mechanical signaling energy into electric power, and the electric power being supplyable to a radio module to send the operating information via a radio message.

2. The switching device of claim 1, wherein the operating information is embodied to be signaled mechanically by a signaling striker.

3. The switching device of claim 1, wherein the at least one module includes a piezoelectic element to convert the mechanical energy into electric power.

4. The switching device of claim 1, wherein the radio module is an RFID module.

5. The switching device of claim 1, wherein the radio message is a short message.

6. The switching device of claim 1, wherein the at least one module is permanently integrated in the switching device.

7. The switching device of claim 1, wherein the at least one module is installed in the switching device.

8. A receiving device for a switching device, wherein the receiving device is embodied to receive the radio messages and and display as the radio messages as operating information from the switching device of claim 1.

9. The receiving device of claim 8, wherein the receiving device is embodied to receive and display the radio messages as operating information from a plurality of radio modules.

10. The receiving device of claim 8, wherein at least one signaling contact is provided that makes a piece of operating information available.

11. The receiving device of claim 10, wherein the signaling contact is an electrical signaling contact.

12. A method for a switching device, for interrupting at least one electrical circuit, the switching device being configured to signal various operating information mechanically, the operating information being captured mechanically and made available as mechanical signaling energy via signaling contacts, the method comprising:
converting the mechanical signaling energy into electric power; and
producing, using the electric power, a radio message that contains the signaled operating information.

13. The method of claim 12, wherein the produced radio message produced is received and the signaled operating information contained in the radio message is displayed.

14. The method of claim 13, wherein a received piece of signaled operating information is additionally made available via at least one signaling contact.

15. The switching device of claim 1, wherein the switching device is a circuit breaker.

16. The switching device of claim 1, wherein the at least one module includes a plurality of modules.

17. The receiving device of claim 9, wherein at least one signaling contact is provided that makes a piece of operating information available.

18. The receiving device of claim 17, wherein the signaling contact is an electrical signaling contact.

19. The switching device of claim 2, wherein the at least one module includes a piezoelectic element to convert the mechanical energy into electric power.

20. The switching device of claim 2, wherein the radio module is an RFID module.

21. The switching device of claim 2, wherein the radio message is a short message.

22. The switching device of claim 2, wherein the at least one module is permanently integrated in the switching device.

23. The switching device of claim 2, wherein the at least one module is installed in the switching device.
